(19) United States
(12) Patent Application Publication
(10) Pub. No.: US 2018/0248579 A1
(43) Pub. Date: Aug. 30, 2018

(54) MOBILE PHONE CASE HAVING ELECTROMAGNETIC WAVE SHIELDING MEMBER

(71) Applicant: Seung Kyu HWANG, Seoul (KR)

(72) Inventor: Seung Kyu HWANG, Seoul (KR)

(21) Appl. No.: 15/755,553

(22) PCT Filed: Aug. 18, 2016
(86) PCT No.: PCT/KR2016/009115

§ 371 Date: Feb. 27, 2018

(30) Foreign Application Priority Data
Oct. 6, 2015 (KR) 10-2015-0140108

(51) Int. Cl. H04B 1/3827; H04B 1/3888; H04M 1/02

(52) U.S. Cl. CPC H04B 1/3838; H04M 1/0202; H04B 1/3888

(57) ABSTRACT

A mobile phone case having an electromagnetic wave shielding member according to the present invention includes: a base formed thereon such that a mobile phone is retained; and a cover extending from one side of the base so as to cover the front surface of the mobile phone, wherein the cover is formed to comprise an electromagnetic wave shielding member, and comprises an extended shielding portion extending towards one side thereof such that the electromagnetic wave shielding range can be extended.

### TECHNICAL FIELD

The present invention relates to a mobile phone case, and more particularly, to a mobile phone case having an electromagnetic wave shielding member to reduce the transmission of electromagnetic waves generated from a mobile phone to a human body.

### BACKGROUND ART

Generally, a mobile communication terminal including a mobile phone function has various electronic devices densely disposed in a small volume and uses radio waves inevitably for communication with the outside so that a large amount of electromagnetic waves are generated in use.

Particularly, the electromagnetic wave is more generated at the time of a call using the call function, and the electromagnetic wave, generated from the mobile phone at the time of a call, influences the head of the human body at a close distance due to the characteristic that the mobile phone terminal should be in close contact with the head of the human body.

It is already well known that radioactive rays such as X-rays and gamma rays having high energy are dangerous and ultraviolet rays cause various diseases such as skin cancer and the like, and the harmfulness of the radio frequency in the radio frequency of mobile phone terminal has continuously aroused controversy.

The controversy of the harmfulness of electromagnetic waves has gone through health impact assessment, environmental impact assessment, and the like to continuously modify the standard. However, there is no doubt that the electromagnetic waves of mobile phone used in close contact with the human head are harmful to human body. In addition, it is foreseeable that there will be various risk factors that can be found in the future.

Accordingly, technologies of adding electromagnetic wave shielding means to a case for accommodating the mobile phone terminal and protecting it from shock so as to reduce the influence of electromagnetic waves on the human body at the time of a call have been implemented. In Korean Utility Model Publication No. 10-2014-0004616 ‘mobile phone case having electromagnetic wave shielding means’, it is disclosed that an electromagnetic wave shielding means is mounted in a cover member for selectively opening the front surface of the mobile phone so that it is possible to prevent electromagnetic waves from being transmitted to the user.

However, due to the characteristics of a electromagnetic wave formed of an electric field having a vertical waveform and a magnetic field having a horizontal waveform, it is insufficient for blocking the electromagnetic waves influencing the head of the human body to block just only the range corresponding to the front surface of the mobile phone by a shielding member. In addition, there is a disadvantage in that the electromagnetic waves, which influences by radially passing through a portion where the shielding member cannot reach, are still transmitted to the head of the human body.

Therefore, a method for solving such problems is required.

### DISCLOSURE

### Technical Problem

The present invention has been made in view of the above problems, and provides a mobile phone case which has an electromagnetic wave shielding member and has a shielding portion extended to prevent the electromagnetic waves generated from a mobile phone from being transmitted to the human body as much as possible, thereby enhancing the electromagnetic wave shielding effect.

The problems of the present invention are not limited to the above-mentioned problems, and other problems not mentioned can be clearly understood by those skilled in the art from the following description.

### Technical Solution

In an aspect, there is provided a mobile phone case formed to surround at least a portion of an external of a mobile phone. The mobile phone case includes: a an electromagnetic wave shielding member; and an extended shielding portion extending towards one side thereof such that an electromagnetic wave shielding range can be extended.

The mobile phone case further includes: a base on which the mobile phone is retained; and a cover extending from one side of the base so as to cover a front surface of the mobile phone.

The cover and the extended shielding portion includes: a shielding layer formed of an electromagnetic wave shielding member; and an outer covering layer formed to cover up an external of the shielding layer.

The extended shielding portion includes: an unfolding piece formed in a thin fan shape; and a hinge coupling means having a fan-shaped central portion in which a plurality of unfolding pieces are hinge-coupled, wherein the plurality of unfolding pieces are rotated and unfolded around the hinge coupling means.

The mobile phone case further includes: an opening which is formed to be perforated at a position corresponding to a call speaker of the mobile phone in a front surface of the cover; and a circular arc opening which is formed in the extended shielding portion and opened in a circular arc shape to be intersect with the opening.

The extended shielding portion includes a shielding slide which is formed to overlap with the cover and slidably accommodated in the cover or extended to one side.

The shielding slide includes: a movement slit which is formed in a center of the cover in a longitudinal direction; and a moving button which has an intermediate portion that is restrained in the movement slit, has one end coupled to a front surface of the shielding slide, and has the other end protruding to a front surface of the cover.

The mobile phone case further includes: an opening which is formed to be perforated at a position corresponding to a call speaker of the mobile phone in a front surface of the cover; and a cross opening which is formed in a center of the shielding slide and opened up and down in a longitudinal direction, wherein at least a part of the cross opening is crossed with the opening of the cover.

### Advantageous Effects

In order to solve the above-described problems, a mobile phone case having an electromagnetic wave shielding member according to the present invention includes a mobile phone case, which is adjacent to a head of a user together with a mobile phone at the time of a call, that has an electromagnetic wave shielding member, and allows the electromagnetic wave shielding member to be extended and unfolded to the side of the case, thereby widening the electromagnetic wave shielding range so that electromagnetic waves generated from the mobile phone cannot reach the human body.

The effects of the present invention are not limited to the effects mentioned above, and other effects not mentioned can be clearly understood by those skilled in the art from the description of the claims.

### DESCRIPTION OF DRAWINGS

FIG. 1 is a perspective view of a mobile phone case having an electromagnetic wave shielding member according to an embodiment of the present invention.

FIG. 2 is a view illustrating a state of use of a mobile phone case having an electromagnetic wave shielding member according to an embodiment of the present invention.

FIG. 3 is a perspective view of a mobile phone case having an electromagnetic wave shielding member according to a first embodiment of the present invention.

FIG. 4 is a view illustrating a state of use of a mobile phone case having an electromagnetic wave shielding member according to a first embodiment of the present invention.

FIG. 5 is a perspective view of a mobile phone case having an electromagnetic wave shielding member according to a second embodiment of the present invention.

FIG. 6 is a view illustrating a state of use of a mobile phone case having an electromagnetic wave shielding member according to a second embodiment of the present invention.

### MODE FOR INVENTION

Hereinafter, preferred embodiments of the present invention will be described with reference to the accompanying drawings. In describing the present embodiment, the same designations and the same reference numerals are used for the same components, and further description thereof will be omitted.

A mobile phone case having an electromagnetic wave shielding member according to the present invention may be implemented as follows.

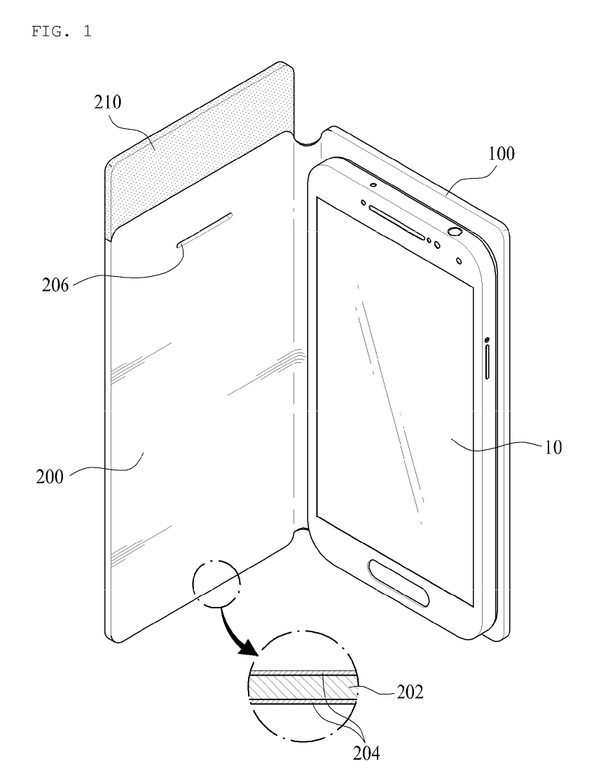

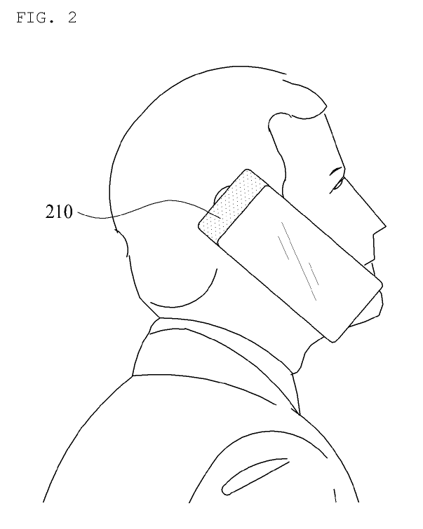

FIG. 1 is a perspective view of a mobile phone case having an electromagnetic wave shielding member according to an embodiment of the present invention, and FIG. 2 is a view illustrating a state of use of a mobile phone case having an electromagnetic wave shielding member according to an embodiment of the present invention.

Referring to FIGS. 1 and 2, the mobile phone case having an electromagnetic wave shielding member according to an embodiment of the present invention may cover at least a part of the outer surface of a mobile phone 10 to protect the mobile phone 10 from shock or contamination, or may be applied various kinds of mobile phone cases for enhancing the aesthetic function of the mobile phone, or the like. The mobile phone case having the electromagnetic wave shielding member according to an embodiment of the present invention may include an electromagnetic shielding member in a mobile phone case, and may include an extended shielding portion 210 formed to be equipped with an electromagnetic shielding member.

According to an embodiment of the present invention, a mobile phone case may include a base 100 on which the mobile phone 10 is retained and a cover 200 formed to extend from one side of the base to cover the front surface of the mobile phone 10. The cover 200 may include an extended shielding portion 210 formed to include an electromagnetic wave shielding member and extend the electromagnetic wave shielding range to one side.

Each of the above-described configurations will be described in detail below.

According to an embodiment of the present invention, the base 100 formed to retain the mobile phone 10 may be implemented by a plate-shaped member formed in a size corresponding to the back surface of the mobile phone 10, and may be adhered and retained on the back surface of the mobile phone 10.

In addition, the base 100 may be formed of a stretchable material capable of accommodating the side and the back side of the mobile phone 10, which is illustrative and may be implemented in various ways according to an embodiment to which the present invention is applied.

The cover 200 may be formed to be connected to one side of the base 100 on which the mobile phone 10 is retained and be foldable at a portion contacting the base 100, and cover the front surface of the mobile phone 10.

The base 100 and the cover 200 may be formed to have an effect of covering and protecting the front and back surfaces of the mobile phone 10 from external shock or contamination.

The cover 200 may be provided with an opening 206 formed as a long hole at a position corresponding to a call speaker of the mobile phone 10 so that a reception sound can be transmitted to the user at the time of a call while the cover covers the front surface of the mobile phone 10.

The extended shielding portion 210 is one side of the cover 200, and, in an embodiment of the present invention, is a member on a surface extending upward.

As shown in a cross-section in FIG. 1, the cover 200 and the extended shielding portion 210 may include a shielding layer 202 formed of an electromagnetic wave shielding member and may cover up the shielding layer 202 by using an outer covering layer 204.

The electromagnetic wave shielding member forming the shielding layer 202 is a conductive material, and is a member capable of shielding electromagnetic waves. The electromagnetic shielding member may be formed of a metal or plastic having a conductive coating, and may be formed of a conductive metal or film.

The outer covering layer 204 may be formed of various materials such as a thin fabric material, a leather, a metal, a plastic, and the like.

As shown in FIG. 2, the mobile phone case having the electromagnetic wave shielding member according to an embodiment of the present invention may cover an area larger than that of the mobile phone 10 between the head of the human body and the mobile phone 10 at the time of a call, thereby blocking the electromagnetic wave radiated from the mobile phone 10.

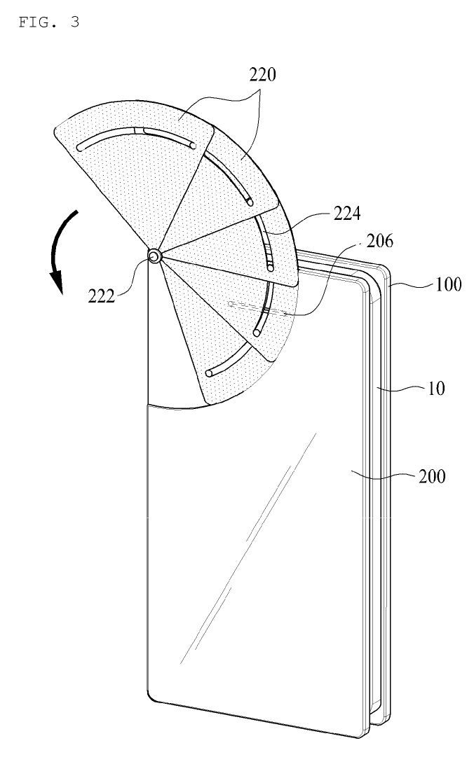

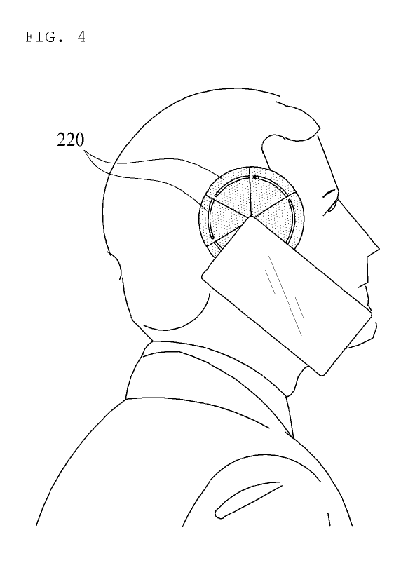

FIG. 3 is a perspective view of a mobile phone case having an electromagnetic wave shielding member according to a first embodiment of the present invention, and FIG. 4 is a view illustrating a state of use of a mobile phone case having an electromagnetic wave shielding member according to a first embodiment of the present invention.

The extended shielding portion 210 according to the first embodiment of the present invention may be implemented as shown in FIG. 3 and FIG. 4.

An unfolding piece 220 is a thin plate-shaped member in the form of a fan, and may include the shielding layer 202 and the outer covering layer 204 which are described above. A plurality of unfolding pieces 220 are provided and coupled by a hinge coupling means 222 in a fan-shaped central portion.

As shown in FIG. 3, the hinge coupling means 222 may be provided at one side edge of the cover, and a plurality of unfolding pieces 220 may be rotated and unfolded around the hinge coupling means 222 to form the extended shielding portion 210.

In this case, a slit-shaped circular arc opening 224 which is opened in parallel with a circular arc may be formed in each unfolding piece 220, and at least a portion of the circular arc opening 224 may be formed to be intersect with the opening 206 through which a reception sound of the call speaker is passed in the cover. This allows a hearer to hear the reception sound even when the unfolding piece 220 is unfolded.

The mobile phone case having the electromagnetic wave shielding member according to the first embodiment of the present invention configured as described above may be implemented as shown in FIG. 4, and may rotate and unfold the unfolding piece 220 around the hinge coupling means 222 at the time of a call, so that the head of the human body can be protected from electromagnetic waves. When not talking, the unfolding piece 220 can be folded and carried and stored.

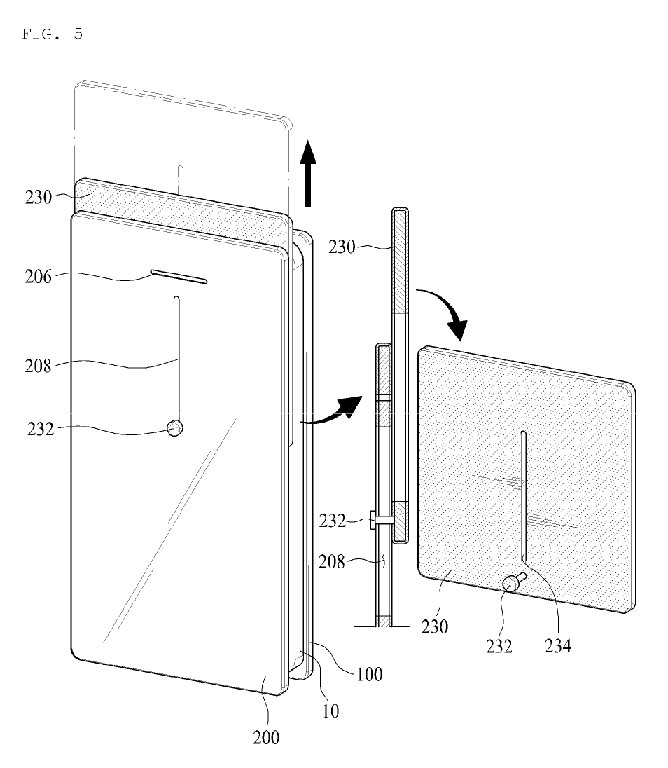

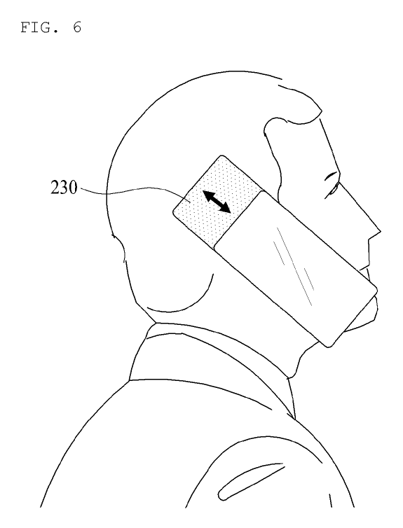

FIG. 5 is a perspective view of a mobile phone case having an electromagnetic wave shielding member according to a second embodiment of the present invention, and FIG. 6 is a view illustrating a state of use of a mobile phone case having an electromagnetic wave shielding member according to a second embodiment of the present invention.

The extended shielding portion 210 according to the second embodiment of the present invention may be implemented as shown in FIG. 5 and FIG. 6.

A shielding slide 230 may include the shielding layer 202 and the sheathing layer 204, may be provided at a width equal to or smaller than that of the cover 200, and may be slid in contact with the inside or outside of the cover 200. However, in the second embodiment, it is assumed that it is formed inside the cover 200.

At this time, a movement slit 208 which is formed to be narrow and long is provided at the center of the cover 200, and an intermediate portion of a moving button 232 extending forward from the front surface of the shielding slide 230 may be inserted into the movement slit 208, so that the left and right sides can be moved up and down while being restrained.

The moving button 232 may be protruded to the front surface of the cover 200 by a certain length so that a user can move the moving button 232 up and down by using his or her hand. When the moving button 232 is moved up and down, the shielding slide 230 may be moved upward and downward as shown in FIG. 5 to be unfolded or be accommodated into the back surface of the cover 200.

A cross opening 234 which is long and narrowly opened in the longitudinal direction may be formed in the shielding slide 230 and at least a part of the cross opening 234 may be crossed with the opening 206 of the cover 200 described above, so that a user can hear the reception sound of the call speaker regardless of the unfolded or accommodated state of the shielding slide 230.

As shown in FIG. 6, the mobile phone case having the electromagnetic wave shielding member according to the second embodiment of the present invention may move the moving button 232 upward at the time of a call so that the shielding slide 230 can be moved to the upper portion of the mobile phone 10 to accomplish a call, thereby prevent the electromagnetic wave from being transmitted to the head of a user. When carrying or storing the mobile phone, the moving button 232 may be downwardly moved to accommodate the shielding slide 230 in the back surface of the cover 200, thereby reducing the volume.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

1. A mobile phone case formed to surround at least a portion of an external of a mobile phone, the mobile phone case comprising:
an electromagnetic wave shielding member; and
an extended shielding portion extending towards one side thereof such that an electromagnetic wave shielding range can be extended.

2. The mobile phone case of claim 1, further comprising:
a base on which the mobile phone is retained; and
a cover extending from one side of the base so as to cover a front surface of the mobile phone.

3. The mobile phone case of claim 2, wherein the cover and the extended shielding portion comprises:
a shielding layer formed of an electromagnetic wave shielding member; and
an outer covering layer formed to cover up an external of the shielding layer.

4. The mobile phone case of claim 2, wherein the extended shielding portion comprises:
an unfolding piece formed in a thin fan shape; and
a hinge coupling means having a fan-shaped central portion in which a plurality of unfolding pieces are hinge-coupled,
wherein the plurality of unfolding pieces are rotated and unfolded around the hinge coupling means.

5. The mobile phone case of claim 4, further comprising:
an opening which is formed to be perforated at a position corresponding to a call speaker of the mobile phone in a front surface of the cover; and
a circular arc opening which is formed in the extended shielding portion and opened in a circular arc shape to be intersect with the opening.

6. The mobile phone case of claim 2, wherein the extended shielding portion comprises a shielding slide which is formed to overlap with the cover and slidably accommodated in the cover or extended to one side.

7. The mobile phone case of claim 6, wherein the shielding slide comprises:
a movement slit which is formed in a center of the cover in a longitudinal direction; and
a moving button which has an intermediate portion that is restrained in the movement slit, has one end coupled to a front surface of the shielding slide, and has the other end protruding to a front surface of the cover.

8. The mobile phone case of claim 7, further comprising:
an opening which is formed to be perforated at a position corresponding to a call speaker of the mobile phone in a front surface of the cover; and
a cross opening which is formed in a center of the shielding slide and opened up and down in a longitudinal direction,
wherein at least a part of the cross opening is crossed with the opening of the cover.
